(19) United States
(12) Patent Application Publication
(10) Pub. No.: US 2016/0358110 A1
(43) Pub. Date: Dec. 8, 2016

(54) ATTRIBUTE-BASED NOMENCLATURE IN SUPPLY CHAINS

(71) Applicant: International Business Machines Corporation, Armonk, NY (US)

(72) Inventors: Ivory W. Knipfer, Rochester, MN (US); Jason S. Lee, Oronoco, MN (US); Antoine G. Sater, Houston, TX (US); Matthew H. Zemke, Rochester, NY (US)

(21) Appl. No.: 14/977,754

(22) Filed: Dec. 22, 2015

Related U.S. Application Data
(63) Continuation of application No. 14/730,356, filed on Jun. 4, 2015.

(51) Int. Cl. G06Q 10/06; G06F 17/30

(52) U.S. Cl. CPC G06Q 10/0633; G06F 17/30867; G06F 17/30876

(57) ABSTRACT

A method, computer program product, and computer system to determine an identifier for a product. A processor compares a plurality of attributes of the product to a hierarchical map of attributes. A processor determines a first portion of the identifier for the product based, at least in part, on a rule associated with the first attribute. A processor determines a second portion of the identifier for the product based, at least in part, on a rule associated with the second attribute. A processor determines an order of the first portion of the identifier and the second portion of the identifier based, at least in part, on the order of the first attribute and the second attribute in the hierarchical map of attributes.

### BACKGROUND OF THE INVENTION

The present invention relates generally to the field of material management, and more particularly to assigning names to products at different points in a supply chain.

A supply chain is a network of suppliers and sellers involved in creating and distributing one or more products to customers. Suppliers along a supply chain takes raw materials, or components from other suppliers, to create a final product that is delivered to an end customer. For a given product, a flow of materials and components along the supply chain can be traced back from an end supplier to initial supplier. Suppliers located higher in the flow of materials and components are referred to upstream suppliers. Suppliers closer to the creation of the final product are referred to downstream suppliers. Supply chain management tracks and provides metrics of component parts along this flow. An upstream supplier is able to gather information regarding components the upstream supplier produces and how they are used by other downstream suppliers in one or more supply chains for a variety of products. Downstream suppliers can use, or source, a variety of components from different upstream suppliers. A downstream supplier is able to gather information describing the components being sourced from upstream suppliers. As each supplier transforms incoming components or materials along a supply chain, a product name or number is associated with the output of the supplier.

### SUMMARY

A method is provided to determine an identifier for a product. A processor compares a plurality of attributes of the product to a hierarchical map of attributes, wherein the plurality of attributes of the product include at least one attribute of an upstream component used in the manufacture of the product. Responsive to a determination that a first attribute of the plurality of attributes of the product matches a first attribute in the hierarchical map of attributes, a processor determine a first portion of the identifier for the product based, at least in part, on a rule associated with the first attribute, wherein the rule assigns a different identifier based on the at least one attribute. Responsive to a determination that a second attribute of the plurality of attributes of the product matches a second attribute in the hierarchical map of attributes, a processor determines a second portion of the identifier for the product based, at least in part, on a rule associated with the second attribute. A processor determine an order of the first portion of the identifier and the second portion of the identifier based, at least in part, on the order of the first attribute and the second attribute in the hierarchical map of attributes. A processor sends the identifier of the product to an upstream supplier via the electronic data interchange, wherein the upstream supplier provided the upstream component. A processor sends the identifier to a supplier downstream in a supply chain via an electronic data interchange. A processor receives an identifier for a downstream product from the supplier downstream in a supply chain via the electronic data interchange. A processor compares the identifier for the product to the identifier for the downstream product. A processor generates a list of differences between the identifier for the product and the identifier for the downstream product, wherein the list of differences include one or more of the plurality of attributes of the product.

### BRIEF DESCRIPTION OF THE SEVERAL VIEWS OF THE DRAWINGS

FIG. 1 is a functional block diagram illustrating an networked environment, in accordance with an exemplary embodiment.

FIG. 2 illustrates operational processes of a translation program based on attributes for a component, on a computing device within the environment of FIG. 1, in accordance with an exemplary embodiment.

FIG. 3 illustrates an example supply chain, in accordance with various embodiments.

FIG. 4 illustrates an example attribute hierarchy, in accordance with various embodiments.

FIG. 5 depicts a block diagram of components of the computing device executing a product name assignment, in accordance with an exemplary embodiment.

### DETAILED DESCRIPTION

While solutions to assigning product names or numbers in a supply chain are known they do not capture all of the relevant information for a component along the flow of a supply chain. Previous solutions used by suppliers assign a unique name or number to each product produced by the supplier. This is often a very costly solution, as it requires all products, and subsequent variations, made by the supplier to be fully known prior to assigning a product name or number. As such, solutions are slow to adapt to changes in products or other changes throughout the supply chain. Furthermore, previous solutions do not account for variations of a component part in a product due to changes made downstream to the component part in a supply chain.

Embodiments of the present invention recognize that by creating a hierarchical map of attributes for products at different points in a supply chain, a more descriptive and accurate name can be selected for the product. Rules are used to select and modify attributes of a product to create a product name. Additionally, the hierarchal attributes of upstream components included in the product can be utilized to create a product name. Rules are defined to select relevant attributes that a supplier selects to best describe a given product. The rules modify the values of the selected attributes to create an easy to read name that describes the key features of a product at any point in a supply chain. Furthermore, the selected attributes, and how they are modified, are shared among each supplier in a supply chain. As such, an upstream supplier is able to determine not only what downstream products are utilized components as made by the upstream supplier but also the attributes selected for product names downstream. As such, the upstream supplier can alter their marketing or production practices to match the attributes selected for downstream products.

In previous solutions, a part number assigned by a supplier limited the type and amount of information available to others suppliers in a supply chain. For example, the revision level, the rework level, the firmware or the code-load level, would not be included in a part number. As such, a supplier would incur a cost, including the release of many specific part numbers, to identify minute differences in variants of the same part. Such costs include costly labeling efforts at the supplier who, in turn, may end up shipping a single part under many different names for each of their customers. As a result, a single part may have a variety of different names across their customer. The cost of determining the attributes of a product are passed along to the customers of the supplier. Each time a part number is released throughout the supply chain, there is a cost that is incurred by members of the supply chain. Other problems that arise from previous solutions include, orders which are unable to ship due to unusable or incompatible parts and later discoveries of rework or part ordering requirements driving.

Embodiments of the present invention provide a name for a material at every level of a supply chain, and apply that name to materials or product for use at a given point in the supply chain. Furthermore, Embodiments of the present invention include the names and attributes of the materials in products used throughout the supply chain, enabling full recognition of usability, applicability, and functionality of the material or products at every level. This enables reporting of material and product usage throughout the supply chain.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

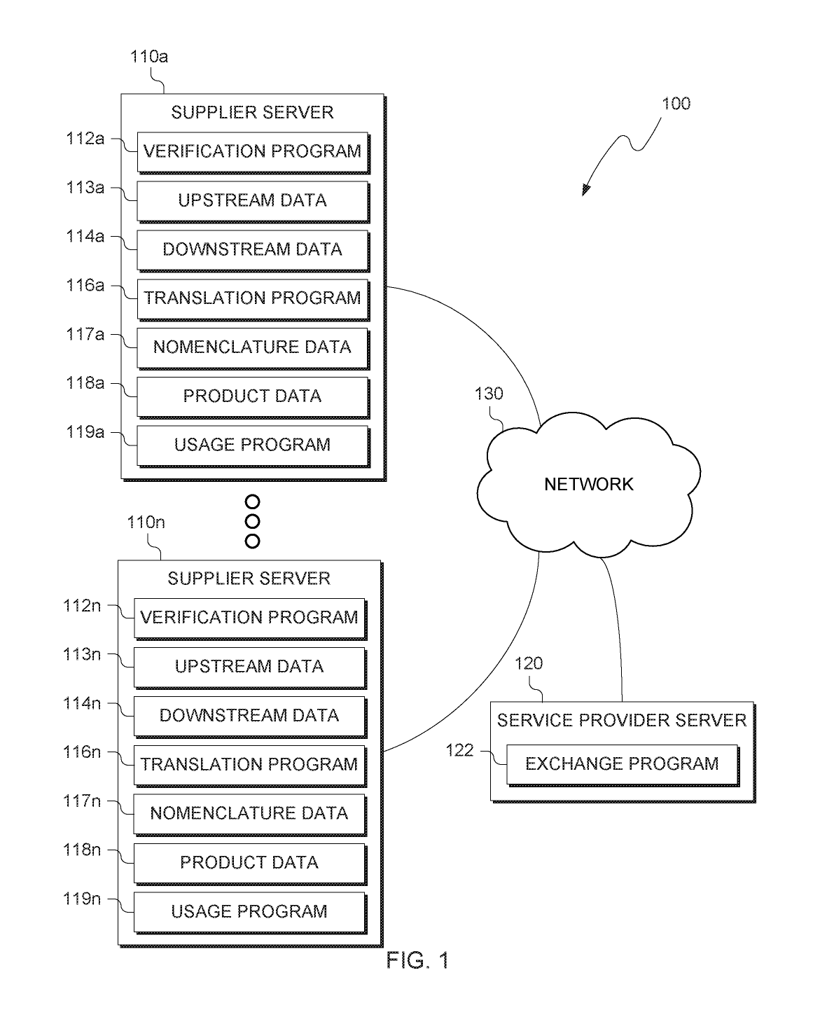

The present invention will now be described in detail with reference to the Figures. FIG. 1 is a functional block diagram illustrating networked environment, generally designated 100, in accordance with one embodiment of the present invention. Networked environment 100 includes supplier servers 110a-n and service provider server 120 connected over network 130. Supplier servers 110a-n each respectively include verification programs 112a-n, upstream data 113a-n, downstream data 114a-n, translation programs 116a-n, nomenclature data 117a-n, product data 118a-n and usage program 119a-n. Service provider server 120 includes exchange program 122.

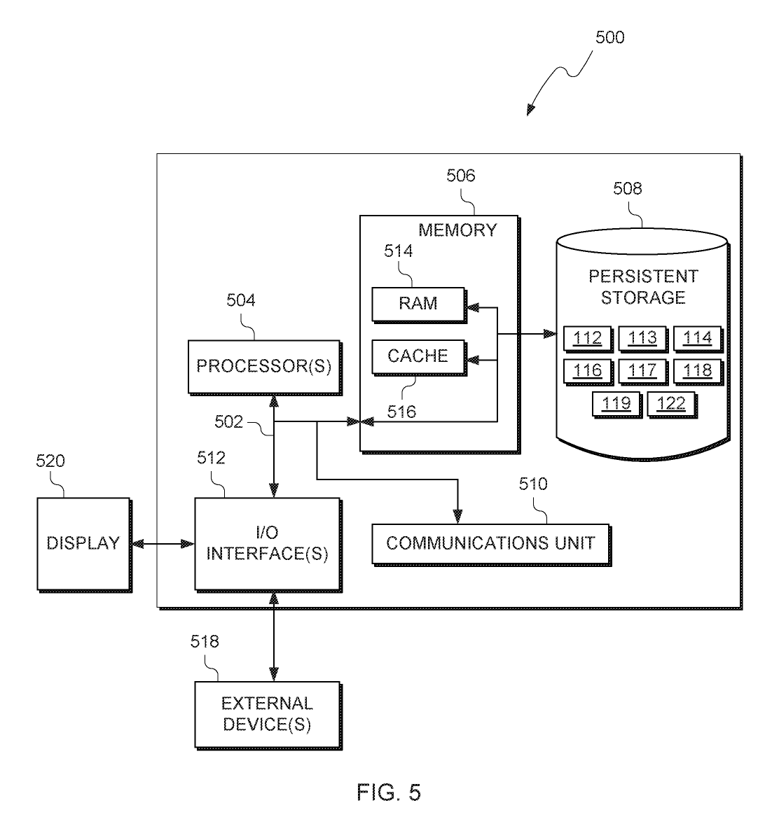

In various embodiments of the present invention, supplier servers 110a-n and service provider server 120 are each a computing device that can be a standalone device, a server, a laptop computer, a tablet computer, a netbook computer, a personal computer (PC), or a desktop computer. In another embodiment, supplier servers 110a-n and service provider server 120 each represent a computing system utilizing clustered computers and components to act as a single pool of seamless resources. In general, supplier servers 110a-n and service provider server 120 can each be any computing device or a combination of devices with access to upstream data 113a-n, downstream data 114a-n, nomenclature data 117a-n and product data 118a-n and is capable of executing verification programs 112a-n, translation programs 116a-n and exchange program 122. Supplier servers 110a-n and service provider server 120 may include internal and external hardware components, as depicted and described in further detail with respect to FIG. 5.

In this exemplary embodiment, verification programs 112a-n, upstream data 113a-n, downstream data 114a-n, translation programs 116a-n, nomenclature data 117a-n and product data 118a-n are stored on a respective supplier server 110a-n. Exchange program 122 is stored on service provider server 120. However, in other embodiments, verification programs 112a-n, upstream data 113a-n, downstream data 114a-n, translation programs 116a-n, nomenclature data 117a-n, product data 118a-n and exchange program 122 may be stored externally and accessed through a communication network, such as network 130. Network 130 can be, for example, a local area network (LAN), a wide area network (WAN) such as the Internet, or a combination of the two, and may include wired, wireless, fiber optic or any other connection known in the art. In general, network 130 can be any combination of connections and protocols that will support communications between each supplier server 110a-n and service provider server 120, in accordance with a desired embodiment of the present invention.

Supplier servers 110a-n communicate via an Electronic Data Interchange (EDI). An EDI provides an automated exchange of documents between applications. Example documents include purchase orders, invoices, and shipping notices. When a document is created on a supplier server of supplier servers 110a-n, the documents is sent directly from one supplier server to other in the supply chain, without human intervention. Once created, the document is distributed to supplier servers 110a-n for other members in the supply chain. An EDI provides fewer errors, lower administrative costs, delivery due to the automation of delivery of documents among the variety of application used by each supplier. An EDI saves companies money by providing by replacing previous processes that required a great deal of human interaction. Previously, orders and receipts were sent using paper documents to convey the sending and receipt of product and materials in a supply chain. The electronic exchange of such documents provide many advantages. With paper documents, manual entry of the documents is required. An EDI provides a company with the advantage of storing the data represented by the document electronically, removing the need of manual entry by a human. Another advantage of an EDI is to eliminate the time involved with correcting manual data entry errors, since the document are automatically received without error. As such, the speed and accuracy of an EDI provides a faster turnaround in processing orders in a supply chain.

In various embodiments, networked environment 100 includes supplier servers 110a-n. Each supplier server 110a-n represents a server operated by a supplier in a supply chain for one or more products. Suppliers in a supply chain include, but are not limited to, raw material providers, manufacturers, assemblers, integrators, distributors, wholesalers, retailers, or any entity that participates in a supply chain to produce, distribute, or sell a product, or parts or materials used in the production of the product, in a supply chain. For example, a raw materials supplier supplies silicon and germanium to an integrated circuits supplier. The integrated circuits supplier produces a processor, using the raw materials, and supplies the processor to a drawer integration supplier. The drawer integration supplier integrates the processor, among other components, to produce a drawer for installation in a server enclosure. The drawer integration supplier supplies the drawer to a server supplier. The server supplier installs the drawer, among other components, to produce a server to sell to an end customer. In the above example, a supplier in the supply chain requests the materials or components desired for use in a value added process from another supplier who produces the requested materials or components. For ease of understanding herein, in a given supply chain, suppliers who provide materials or components to another supplier are referred to upstream suppliers. Similarly, suppliers that order and use the provided materials or components from upstream suppliers are referred to as downstream suppliers. In more complex supply chains, a given supplier can be both an upstream and downstream supplier (e.g., the drawer integration supplier is a downstream supplier relative to the integrated circuit supplier and an upstream supplier to the server supplier). The terms upstream and downstream supplier indicate a supplier's relative position to other suppliers in a supply chain for a given product.

In various embodiments, each supplier server 110a-n includes respective product data 118a-n for materials, components, or products the supplier provides. As discussed herein, product data 118a-n includes an identifier for each material, component, or product the supplier provides. Product data 118a-n also includes material or component requirement data indicating the materials or components required from one or more upstream suppliers to produce a particular product made by the supplier of the respective supplier server 110a-n. For example, a smartphone model has a requirement to include a 32 GB flash memory module supplied by a particular upstream supplier. In some embodiments, each respective product data 118a-n includes the attributes of a product supplied by the respective supplier of supplier server 110a-n. The attributes includes descriptors of the product in addition to descriptors of materials or components comprising the product. Attribute data includes all attributes describing a particular product provided by a supplier. In one embodiment, the identifier of a product in product data 118-a-n is generated based on attribute data of the product in conjunction with nomenclature data 117a-n. The identifier of a product provides a concise and more descriptive name than typical part numbers, by modifying a product's attributes into the identifier, based on nomenclature data 117a-n.

In various embodiments, the respective verification program 112a-n of supplier server 120a-n for a given supplier sends product data 118a-n to one or more verification programs 112a-n of supplier servers 110a-n for upstream suppliers that supply materials or components indicated in the requirement data for a given product. The supplier server 110a-n of the upstream supplier stores the received product data 118a-n in the respective downstream data 114 of the upstream supplier server 110a-n. For example, a PC manufacturer has a laptop product that requires an upstream supplier's hard drive. The respective verification program 112a-n of the PC manufacturer's supplier server 110a-n sends to the respective verification program 112a-n of the upstream hard drive supplier server 110a-n product data 118a-n of the laptop, including the identifier of the laptop, the requirement data for materials and components of the laptop, and attributes of the laptop. In various embodiments, upon receiving the respective product data 118a-n from downstream verification programs 112a-n, upstream verification programs 112a-n verifies the requirement data of the indicated product required in the downstream product reflects the product data 118a-n of the upstream supplier. Downstream supplier server 110a-n stores the verified product data 118a-n of the upstream supplier in the upstream data 113a-n of the downstream supplier.

In various embodiments, the verification program 112a-n for the downstream supplier and the verification program 112a-n for the upstream supplier verify the respective product data 118a-n, upstream data 113a-n and downstream data 114a-n stored on the supplier server 110a-n. Verification programs 112a-n link upstream data 113a-n and downstream data 114a-n to respective product data 118a-n of suppliers that provide the materials, components or products used for the variety of products at each point in a supply chain. The respective verifications programs 112a-n update changes made to identifiers, requirements, or attributes of the components or products in a supply chain. At a given point in the supply chain, based on changes being made to components or products made by suppliers downstream from a respective supplier server 110a-n, the respective verification program 112a-n located at the given point in the supply chain updates the respective downstream data 114a-n for the updated products or components. Similarly, the respective verification program 112a-n updates changes being made to components or products upstream from a respective supplier server 110a-n to the respective upstream data 113a-n. As changes are made to a supplier's product data 118a-n (e.g., attributes, requirements, or the identifier is changed for a product), the upstream data 113a-n of downstream suppliers or the downstream data 114a-n of upstream suppliers are updated to reflect changes made to a product or component by a supplier within a supply chain. In some embodiments, product data 118a-n includes upstream data 118a-n of suppliers for components or materials used in the product. For example, once verification program 112a-n receives upstream product data 118a-n, the identifiers, attributes and requirements of upstream components or materials are included in the product data 118a-n of the supplier.

In some embodiments, verification program 112a-n of supplier servers 110a-n send product data 118a-n to exchange program 122 of service provider server 120. Exchange program 122 determines the requirements of products in product data 118a-n to generate a supply chain. Exchange program 122 identifies upstream suppliers from requirements in product data 118a-n. Exchange program 122 sends the identifiers and attributes of the product that requires components from an upstream supplier to the respective verification program 112a-n of the respective upstream supplier server 110a-n. The respective verification program 112a-n stores the received product data 118a-n in downstream data 114a-n. The respective upstream verification program 112a-n sends to exchange program 122 the relevant product data 118a-n that is required for downstream products. Exchange program 122 sends the relevant product data 118a-n that is required for downstream products to the downstream supplier. In response, the respective verification program 112a-n of the downstream supplier server 110a-n stores the upstream product data in the respective upstream data 113a-n. As changes or updates are made to the respective product data 118a-n of a supplier server 110a-n, the respective verification program 112a-n sends the updated product data 118a-n to exchange program 122. In response, exchange program 122 sends the update product data 118a-n to verification programs 112a-n of other supplier servers 110a-n in the supply chain of the product that has been updated.

In various embodiments, the respective translation programs 116a-n for a supplier generates an identifier for products produced by the supplier as stored in the respective product data 118a-n. For a given product, product data 118a-n includes attributes of the product. For example, attributes of a product include product names or numbers for components of the product, materials or assembly procedures used to create the product, business or marketing assignments (e.g., brand names or product lines), and version, production or usage information of the product. Based on the respective nomenclature data 117a-n for a supplier and attributes for a product in the respective product data 118a-n for the supplier, the respective translation program 116a-n for the given supplier generates an identifier for a product produced by the supplier.

In various embodiments, nomenclature data 117a-n includes a hierarchical map of attribute data for products stored in product data 118a-n. A hierarchical map for a product provides an order to sort the attributes of the product when creating an identifier. The hierarchical map for a product includes categories for each type of attribute of a product. The hierarchical map provides an order to evaluate the attributes based on one or more rules, as discussed herein. In various embodiments, the respective translation program 116a-n for a supplier receives input from a user to create a hierarchical map for one or more products. In some embodiments, a hierarchical map is created for each product produced by a supplier. In other embodiments, a hierarchical map is shared for a group of products (e.g., a product line shares a hierarchical map).

In various embodiments, nomenclature data 117a-n includes one or more rules for creating an identifier, or portions of an identifier, based on attribute values for a product in product data 118a-n for a respective supplier server 110a-n of a given supplier. A translation program 116a-n for a given supplier retrieves attributes from the respective product data 118a-n for the given supplier. The translation program 116a-n applies the one or more rules to the attributes of a product, and based on the order indicated in the hierarchical map, creates an identifier for the product. Example rules include, but are not limited to, including or excluding attributes of the product, altering the attributes of the product (e.g., shortening the attribute or assigning different identifiers based on the attribute), or including additional information associated with the attribute. In some embodiments, one or more rules are associated with formatting the attributes of the product. For example, a rule is defined to insert dashes between attributes. As another example, a rule is defined such that all alphabetic characters are capitalized.

In some embodiments, a translation program 116a-n receives input from a user of a given supplier for the respective supplier server 110a-n that the user is providing input in order to create one or more rules. The user defines a rule that includes the product or products in product data 118a-n to be applied by the rule. Additionally, the user defines how the attributes of the included product or products are to be handled when creating an identifier. In other embodiments, nomenclature data 117a-n includes one or more pre-existing rules. The respective translation program 116a-n of the supplier receives input from the user to select one or more pre-existing rules in addition to the product or products the rule is to be applied.

As an example, a motherboard manufacturer is a supplier in a supply chain. Example upstream suppliers include chip manufactures for integrated peripherals used in the motherboard or a chipset manufacturer for interfaces between peripherals and components of the motherboard. Example downstream suppliers include wholesalers or retailers, who sell the motherboard to end customers, and integrators, who integrate other devices and peripherals with the motherboard to create a desktop computer. In this example, the motherboard includes a chipset from Upstream Supplier A. The translation program 116a-n of Upstream Supplier A creates the name “AA-1234-BB” for the chipset, where “AA” is an attribute that represents the brand or family of the chipset, “1234” is an attribute that represents the model, and “BB” is an additional attribute of the chipset. The name is stored as the identifier for the product in the product data 118a-n of Upstream Supplier A. The respective verification programs 112a-n of the motherboard manufacturer and Upstream Supplier A send and receive the respective product data 118a-n for related products and components in a supply chain. As such, the identifier “AA-1234-BB” for the chipset is stored in the attributes of the product data 118a-n of the motherboard manufacturer. Similarly, for each component or material used in a product, the respective upstream product data 118a-n of the component or material is stored as an attribute of the product data 118a-n of the motherboard manufacturer, including the identifier and attributes of the upstream component or material (e.g., materials or components of the upstream component).

Continuing with the example, the motherboard also includes, among other peripherals, an audio peripheral chip and interface provided from manufacturer B with the identifier “AUDIO-987”, where “AUDIO” is a product group of the chip and “987” is a specific variant. In addition to the components provided by upstream suppliers, the motherboard product is produced to include a variety of features, or attributes, associated with the manufacture and assembly of the product. One feature is the form factor or size of the motherboard. For this example, the motherboard is produced to be a “small” form factor, where other motherboards may be “Large”. Another additional features includes the number and type of ports, such as “12 USB 2.0” ports and “4 USB 3.0” ports. Furthermore, a product name, “MOBO1” is assigned to the product as an attribute.

Using the attributes of the product and the attributes or identifiers of the components parts of the product, the translation program 116a-n of the motherboard manufacturer creates an identifier for the motherboard product described above. The translation program 116a-n of the motherboard manufacturer determines an order of attributes based on the hierarchical map stored in the respective nomenclature data 117a-n of the motherboard manufacturer. For each attribute, the translation program 116a-n of the motherboard manufacturer applies any rules in the respective nomenclature data 117a-n of the motherboard manufacturer to the attribute.

In this example, a hierarchal map lists attributes in order (i) product name, (ii) chipset, (iii) form factor, (iv) ports, and (v) peripherals. The product name attribute has an associated rule to include the name as entered in the attribute (e.g., “MOBO1” is used). The chipset attribute has an associated rule to include only the family attribute of the chipset (e.g., “AA”), excluding the other attributes of the component chipset (e.g., “1234-BB”). The form factor attribute has an associated rule to map the attribute to a predetermined name (e.g., “Small” is translated to “SM” for the identifier, if the form factor was “Large” then the identifier for the attribute is translated to “LG”). The ports attribute has a rule to exclude the number and type of ports from the identifier. In such cases, the hierarchical map can be used for other products and another rule set can be created for a different product where the number and types of ports are included in the identifier. The peripheral attribute has an associated rule to include the variant attribute of the audio peripheral but exclude the product group attribute (e.g., the portion of the identifier is “987”). Finally, a rule for the identifier is defined for formatting the attributes when combined. In this example, a rule to insert spaces in between attributes selected and formatted by the rules is associated with the identifier for the motherboard product. As such, the translation program 116a-n of the motherboard manufacturer generates the identifier “MOBO1 AA SM 987” for this particular motherboard product.

In various embodiments, once the respective translation program 116a-n of a supplier determines the identifier of a product, the identifier is stored in the respective product data 118a-n of the supplier. As discussed herein, various verification programs 112a-n of upstream and downstream suppliers update the respective upstream data 113a-n and downstream data 114a-n for suppliers involved in the supply chain for the product. As such, identifiers for components used in products along the supply chain, as well as the final product delivered to end consumers, are received by each supplier in a given supply chain. In addition to the attributes of each product and their components, the identifier selected by a supplier indicates the attributes or features that the supplier recognizes as a valuable indicator of the product. Therefore, the selected attributes used to generate an identifier provides upstream suppliers insight into how their product is used or marketed to other downstream suppliers or customers.

In various embodiments, the respective usage program 119a-n of a supplier determines the identifiers used in the respective product data 118a-n of downstream suppliers. The respective usage program 119a-n of a supplier provides a report indicating the attributes used in identifiers of products that incorporate or use one or more products produced by the supplier. For attributes indicating features of a product, attributes included in identifiers further downstream indicate a popularity or preference for the feature. Conversely, attributes excluded in identifiers further downstream indicate an unpopularity or lack of preference of the attribute. Using the above example of a motherboard manufacturer, a downstream PC integrator uses the motherboard product in a desktop. The PC integrator creates an identifier for the desktop. The identifier includes nomenclature for the number of ports provided by the motherboard. The respective usage program 119a-n of the motherboard supplier provides a report indicating that the product as used downstream includes the number of ports. As such, the supplier can produce marketing material promoting the number of ports. Similarly, the supplier can update the rules in the nomenclature data 117a-n of the supplier to include the number of ports in the identifier for the motherboard.

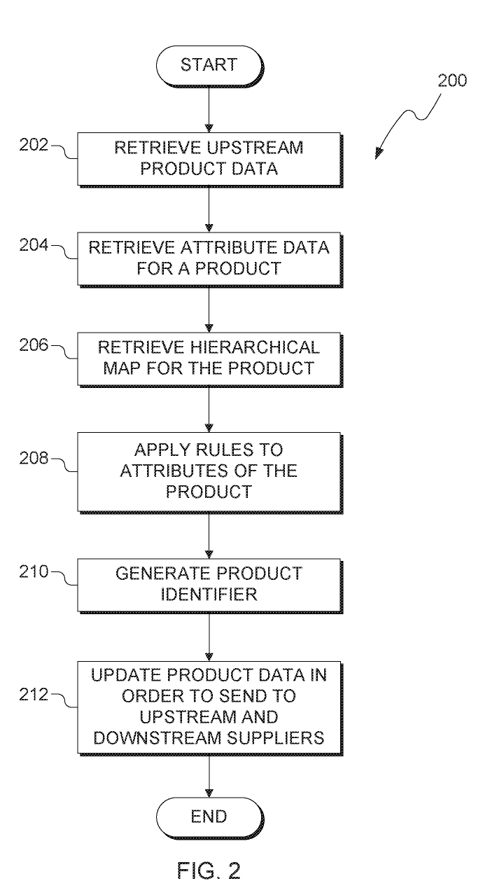

FIG. 2 illustrates operational processes, generally designated 200, of translation program 116a-n based on attributes for a component, on a computing device within the environment of FIG. 1, in accordance with an exemplary embodiment.

In process 202, the respective translation program 116a-n of a supplier retrieves upstream product data 118a-n stored in upstream data 113a-n of the given supplier. As discussed herein, verification programs 112a-n of upstream supplier send respective product data 118a-n, including the identifiers and attributes of the components used in a product of the supplier. The respective translation program 116a-n of the supplier retrieves the attributes of component parts used in the production of a given product.

In process 204, the respective translation program 116a-n of a supplier retrieves attribute data for a product being produced by the supplier. When a product is selected for production, the respective translation program 116a-n of the supplier receives attributes describing the product and the products production. The respective translation program 116a-n of the supplier stores the received attributes in the respective product data 118a-n of the supplier. For example, features of the product are stored into product data 118a-n. When an identifier is requested, the respective translation program 116a-n of the supplier retrieves the attributes.

In process 206, the respective translation program 116a-n of a supplier retrieves the hierarchical map associated with the product. The hierarchical map determines the order the attributes of the product and components used in the product are evaluated by the respective translation program 116a-n of the supplier. For example, the product name attribute is indicated to be evaluated prior to a component's attribute. In process 208, the respective translation program 116a-n of the supplier applies one or more rules associated with the attributes of the product, using the order indicated in process 206. Each rule may include or exclude an attribute from being included in an identifier. Additionally, the attribute may be modified or changed based on a rule.

In process 210, the respective translation program 116a-n of the supplier generates an identifier for the product. Based on the order defined in the hierarchal map, the respective translation program 116a-n of the supplier combines the results from the rules associated with each attribute. In some embodiments, the respective translation program 116a-n of the supplier applies additional rules to format the identifier (e.g., capitalize text or insert characters for readability). In process 212, the respective translation program 116a-n of the supplier updates the respective product data 118a-n of the supplier with the generated identifier. In response, the respective verification program 112a-n of the supplier sends the selected identifier and attributes of the product to upstream and downstream suppliers involved in the supply chain of the product.

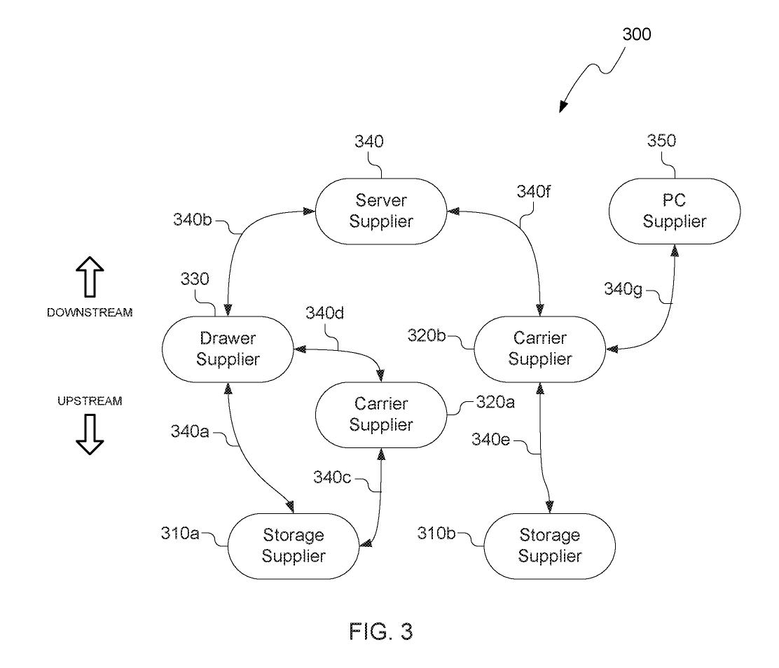

FIG. 3 illustrates example supply chain, generally designated 300, in accordance with various embodiments. Supply Chain 300 includes, storage suppliers 310a-b, carrier suppliers 320a-b, drawer supplier 330, server supplier 340 and PC supplier 350. Supply Chain 300 also includes interchanges 340a-g that each indicate the path of components and products through supply chain 300. For each interchange 340a-g, the product data 118a-n of the upstream supplier and downstream supplier is shared, as discussed herein. In this example supply chain 300, storage suppliers 310a-b both produce storage devices for use in a variety of products. Specifically, storage supplier 310a supplies storage devices to carrier supplier 320a (interchange 340c) and drawer supplier 330 (interchange 340a). Storage supplier 310b supplies storage devices to carrier supplier 320b (interchange 340e) and PC supplier 350 (interchange 340g). Carrier suppliers 320a-b provide testing and integration of the storage devices supplied by storage suppliers 310a-b. Carrier suppliers 320a-b ensure the storage devices meet certain standards necessary in a high speed and usage environment (e.g., in a telecommunications environment). Carrier suppliers 320a-b, as their product, provide verified hard drives to other suppliers (interchange 340d). Drawer supplier 330 receives verified hard drives from carrier supplier 320a and integrates the hard drive, among other components, into a drawer for use in a server. Server supplier 340 receives drawers from drawer supplier 330 (interchange 340b) in addition to storage devices verified by carrier supplier 320b (interchange 340f). Server supplier 340 integrates the drawers, storage devices and other components into a server enclosure. Server supplier 340 sells the integrated server enclosures to customers, such as data centers. Additionally, carrier supplier 320b also provides verified storage devices to PC supplier 350 (interchange 340g).

In one scenario, carrier supplier 320a is testing a particular line of hard drives produced by storage supplier 310b. Carrier supplier 320a assigns a score regarding the reliability of the line of hard drives as an attribute in the respective product data 118a-n of the carrier supplier. For example, the hard drives have a 99% availability score (e.g., the hard drive is not available due to failure for 1% of the testing period). Another line of hard drives score lower with a 90% availability score. When carrier supplier 320a creates an identifier for both the first line of hard drives and the second line of hard drives, the availability score is included. Since the customers of a carrier supplier (e.g., server providers and drawer producers) typically care about the availability (i.e., failure information) of the components in their products, the carriers select the availability score as an attribute to include in and designate the products the carrier provides.

Continuing with the scenario, server supplier 340 purchases both lines of hard drives with the first line integrated with a first brand of servers and the second line integrated with a second brand of servers. When creating identifiers for the first line of servers, server supplier 340 includes the availability score of the hard drives due to their high availability. Conversely, when creating identifiers for the second line of servers, server supplier 340 excludes the availability score of the hard drives due to their lower score. As discussed herein, downstream product data (e.g., attributes and identifiers) is shared with upstream suppliers. The respective usage program 119a-n of storage supplier 310b reports which attributes of products produced by storage supplier 310b are used in identifiers in downstream products of a supply chain. Storage supplier 310b identifies that the lower availability score hard drives are not a recognized feature of the downstream server, as a result other suppliers may be chosen in the future. Storage supplier 310b can evaluate such usage scenarios to make decisions to avoid lost business (e.g., focus spending of improvements to the second line of hard drives). In a similar scenario, the second line of hard drives, as a result of the lower availability score, is instead provided to PC supplier 350 for installation into desktops. Storage supplier 310b identifies that the hard drives are provided to PC supplier 350 and as a result, decides to directly provide the hard drives to PC supplier 350.

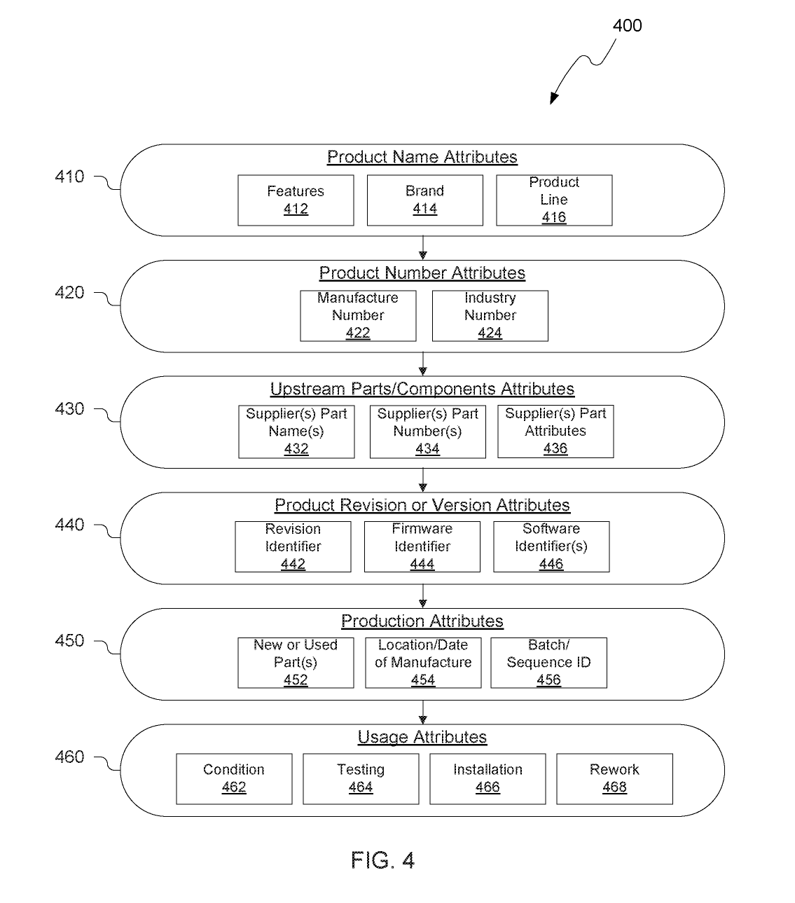

FIG. 4 illustrates an example attribute hierarchy 400, in accordance with various embodiments of the present invention. Attribute hierarchy 400 includes multiple categories of attributes each including attributes belonging to the group. A hierarchical map may include or exclude any of the following attributes. Furthermore, a hierarchical map throughout a supply chain may remain the same or change for each supplier. The following is an illustrative list of attributes for products in a supply chain for integration of electrical components. One skilled in the art will appreciate that the attributes may apply to other types of supply chains.

Product name attributes category 410 include related to the name or designation of a product by the supplier. Features 412 include descriptive features to be included in the identifier, such as size, materials and structure. Brand 414 includes names used for products in marketing and promotion of a product. Product line 416 includes names for groupings of products with similar attributes. Product name attributes category 410 includes top level descriptors used to market a product or component. Such attributes are typical included first in an identifier to leverage brand recognition.

Product number attributes category 420 include numbers or alphanumerical strings that designate a group, particular product, or line of products. Manufacture number 422 include part numbers designated by a supplier and are typically unique to the supplier. Industry number 424 include numbers generally accepted within an industry (e.g., HDD for hard disk drive). Upstream parts/components attribute category 430 includes the part names (e.g., the identifiers discussed herein) or part numbers of component parts used in a given product. Supplier part name 432 includes the identifiers of part provided by upstream supplier (e.g., identifiers generated by translation program 116a-n of an upstream supplier). Supplier part number 434 includes numbers indicating the part provided by upstream supplier (e.g., manufacture number 422 of an upstream supplier). Supplier part attributes 436 includes the attributes of the part or components similar to the attributes discussed in this example.

Product revision or version attributes category 440 include revisioning or additional changes to software included in the product. For example, a supplier may install a custom firmware to a component. An upstream supplier may be interested in such alterations to the software of a product in order to track the version of software offered to suppliers and customers in the supply chain. Revision identifier 442 includes a tracking number of changes made to a product throughout the products production. Firmware identifier 444 includes a firmware version of a product. Tracking and identifying firmware helps determine performance and features of a product in the supply chain. Software identifier 446 includes identifiers for other types of software included with the product.

Production attributes category 450 includes attributes to track the production status of the product or component parts of the product. New or used part 452 includes a status attribute indicating if the product or component is new or used. New or used part 452 attribute enables tracking and differentiation of the condition of the product. Location/Date of Manufacture 454 includes the location (e.g., facility) and the date a product is created to track issues with certain locations or time frames. Batch/Sequence ID 456 includes identifiers regarding a group of products produced in similar conditions (e.g., all products produced during a given day) and, in some cases, a unique number for each product.

Usage attributes category 460 includes attributes indicating how a product was handled prior to delivery. Condition 462 attribute indicates if any alterations or accidents occurred during production. Testing 464 attribute indicates the amount and type of testing or verification of a product. Installation 466 attribute indicates the type of delivery or installation of a product (e.g., installed on-site versus off-site). Rework 468 includes attributes to indicate any changes made to the product during delivery and prior to acceptance by a customer.

FIG. 5 depicts a block diagram, 500, of components of supplier servers 110a-n and service provider server 120, in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Supplier servers 110a-n and service provider server 120 each includes communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 514 and cache memory 516. In general, memory 506 can include any suitable volatile or non-volatile computer-readable storage media.

Verification programs 112a-n, upstream data 113a-n, downstream data 114a-n, translation programs 116a-n, nomenclature data 117a-n, product data 118a-n and usage programs 119a-n are each stored in a respective persistent storage 508 for execution and/or access by one or more of the respective computer processors 504 via one or more memories of memory 506. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer-readable storage medium that is also part of persistent storage X08.

Communications unit 510, in these examples, provides for communications with other data processing systems or devices, including resources of network 130. In these examples, communications unit 510 includes one or more network interface cards. Communications unit 510 may provide communications through the use of either or both physical and wireless communications links. Verification programs 112a-n, upstream data 113a-n, downstream data 114a-n, translation programs 116a-n, nomenclature data 117a-n, product data 118a-n and usage programs 119a-n may be downloaded to persistent storage 508 through communications unit 510.

I/O interface(s) 512 allows for input and output of data with other devices that may each be connected to supplier servers 110a-n and service provider server 120. For example, I/O interface 512 may provide a connection to external devices 518 such as a keyboard, keypad, a touch screen, and/or some other suitable input device. External devices 518 can also include portable computer-readable storage media such as, for example, thumb drives, portable optical or magnetic disks, and memory cards. Software and data used to practice embodiments of the present invention, e.g., verification programs 112a-n, upstream data 113a-n, downstream data 114a-n, translation programs 116a-n, nomenclature data 117a-n, product data 118a-n and usage programs 119a-n, can each be stored on such portable computer-readable storage media and can be loaded onto persistent storage 508 via I/O interface(s) 512. I/O interface(s) 512 also connect to a display 520.

Display 520 provides a mechanism to display data to a user and may be, for example, a computer monitor, or a television screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be noted that the term(s) “Smalltalk” and the like may be subject to trademark rights in various jurisdictions throughout the world and are used here only in reference to the products or services properly denominated by the marks to the extent that such trademark rights may exist.

What is claimed is:

1. A method for determining an identifier for a product, the method comprising:
comparing, by one or more processors, a plurality of attributes of the product to a hierarchical map of attributes, wherein the plurality of attributes of the product include at least one attribute of an upstream component used in the manufacture of the product;
responsive to a determination that a first attribute of the plurality of attributes of the product matches a first attribute in the hierarchical map of attributes, determining, by the one or more processors, a first portion of the identifier for the product based, at least in part, on a rule associated with the first attribute, wherein the rule assigns a different identifier based on the at least one attribute;
responsive to a determination that a second attribute of the plurality of attributes of the product matches a second attribute in the hierarchical map of attributes, determining, by the one or more processors, a second portion of the identifier for the product based, at least in part, on a rule associated with the second attribute;
determining, by the one or more processors, an order of the first portion of the identifier and the second portion of the identifier based, at least in part, on the order of the first attribute and the second attribute in the hierarchical map of attributes;
sending, by the one or more processors, the identifier of the product to an upstream supplier via the electronic data interchange, wherein the upstream supplier provided the upstream component;
sending, by the one or more processors, the identifier to a supplier downstream in a supply chain via an electronic data interchange;
receiving, by the one or more processors, an identifier for a downstream product from the supplier downstream in a supply chain via the electronic data interchange;
comparing, by the one or more processors, the identifier for the product to the identifier for the downstream product; and
generating, by the one or more processors, a list of differences between the identifier for the product and the identifier for the downstream product, wherein the list of differences include one or more of the plurality of attributes of the product.
